(19) United States
(12) Patent Application Publication
(10) Pub. No.: US 2003/0135788 A1
(43) Pub. Date: Jul. 17, 2003

(54) Profile feedback assisted null check removal

(76) Inventor: Raj Prakash, Saratoga, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/044,731

(22) Filed: Jan. 11, 2002

(51) Int. Cl. H02H 3/05

(52) U.S. Cl. 714/38

(57) ABSTRACT

A method and system for bypassing an infrequent null pointer condition when compiling a source program. The method and system includes identifying the occurrences of null pointer condition. The method and system further includes determining if such occurrences are so infrequent as to be avoided during the running of the executable program. Null pointer conditions are placed in a fault to target translation table that provides that whenever the particular null pointer condition is encountered, the program is directed to an acceptable program line.

### BACKGROUND OF THE INVENTION

This invention relates to a method and system that minimizes or eliminates looking at null pointers during compilation of a software program.

### DESCRIPTION OF THE RELATED ART

Application programming languages such as the C programming language make use of a programming construct known as a pointer. A pointer is an address of a computer memory location to which a program is directed to for particular information. In the written program code language, common practice is to use a prefix of “p” before a variable when a pointer is designated. When information is retrieved from a memory location where a pointer points to the memory location, the action is typically referred to as “location lookup” or “pointer de-referencing.”

In particular instances pointers in a program can have a value of null. A null value typically is a zero (0). In instances when the pointer has a value of null, the pointer is referred to as a null pointer. Null pointers do not point to a valid memory location; therefore null pointers can not be used to perform lookup. If the program; however, ignores a null pointer condition, and attempts to use a null pointer to perform a lookup, an exception event known as a fault in the program is experienced. To avoid these fault conditions from occurring, programs check the value of a pointer before performing location lookup using the pointer. If the pointer points to a null value, no lookup is performed. A null pointer may or may not be indicative of a failure or error condition. For certain cases, informing of an error condition is necessary.

Now referring to FIG. 1, a block diagram illustrates a group of records that are interrelated by pointers. FIG. 1 illustrates maintenance of a list of records, with each record in the list having a pointer that is directed to another record in the list. In this particular example the last record in the list has a null pointer to indicate the end of the list. Specifically record 100 has pointer 105, where pointer 105 points to a subsequent record in the list. A pointer 110 can point to record 100, where pointer 110 is directed to the beginning of the record list. Pointer 105 points to record 115, where record 115 is the subsequent record in the list following record 100. Record 115 has a pointer 120. Pointer 120 points to record 125, where record 125 follows record 115 in the list. Record 125 has a pointer 130. Pointer 130 points to record 135, where record 135 follows record 125 in the list. Record 135 has a pointer 140, in this particular example pointer 140 is a null pointer and indicates the end of the list.

When an application program is run, the application program can check for unexpected null pointer conditions that can arise from unintentional programming errors or unexpected inputs to the program. These null pointer conditions typically do not occur but typical application programs are written to watch out for such null pointer conditions, in the event of programming errors or unexpected input to the program, and to report such an error.

The following code listing illustrates an example of testing for a null pointer. A check is performed to determine if the pointer is null, line 100. If the pointer is not null the program proceeds as normal doing a lookup using the pointer, line 200. If the pointer is null, as provide by line 300, an error is reported as provided by line 400.

| | |
|---|---|
| 100 | if (p != NULL) |

| | |
|---|---|
| 200 | /* lookup content at address p */ |

| | |
|---|---|
| 300 | else |

| | |
|---|---|
| 400 | error ( ); |

When programs are run, programs are required to check for pointers having a null value before the program performs lookups using the pointers. The null pointer check procedure must be performed although pointers are rarely or in many cases never null. Because of the infrequency of null pointers, performing the check for the null values tends to add extra time when a program is ran. Removal of such a check can significantly speed up the program; however, null pointer check is still required to allow the program to perform properly.

### SUMMARY OF THE INVENTION

What is needed and is disclosed herein is an invention that provides for a method and a system to determine the frequency of the occurrence of null pointers and to bypass looking up such null pointers during the running of an application program.

In an embodiment of the invention, when a source program is compiled a fault to target translation table is created in which an infrequent null pointer condition is identified. In the fault to target translation table the infrequent null pointer condition is related to a procedural instruction or line in the program in which to proceed if the null pointer condition is encountered. The source program is then compiled into an executable program that bypasses the identified null pointer condition.

In certain embodiments of the invention, statistics are gathered as to the number of occurrences that a null pointer condition takes place and the infrequent null pointer condition is entered in the fault to target translation table if an acceptable rate of occurrence is not met.

In other embodiments of the invention, a separate handler program provides a compiler information stored in the fault to target translation table.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings. The use of the same reference number throughout the figures designates a like or similar element.

FIG. 1 is a block diagram illustrating a hierarchy of conditions related to a “0” value in a program during compile.

FIG. 2A is a block diagram illustrating a first pass program compile.

FIG. 2B is a block diagram illustrating a program in which profile feedback information is extracted.

FIG. 2C is a block diagram illustrating optimized program feedback.

FIG. 3 is a block diagram illustrating the hierarchy of conditions related to a null pointer check in a program during compilation.

FIG. 4 is is a fault to target translation table

FIG. 5 is a flow chart illustrating source program compilation.

FIG. 6 is a block diagram illustrating a network environment in which a system according to the present invention may be practiced.

FIG. 7 is a block diagram depicting a computer system suitable for implementing the present invention, and example of one or more of client computers.

FIG. 8 is a block diagram depicting a network in which a computer system is coupled to an internetwork.

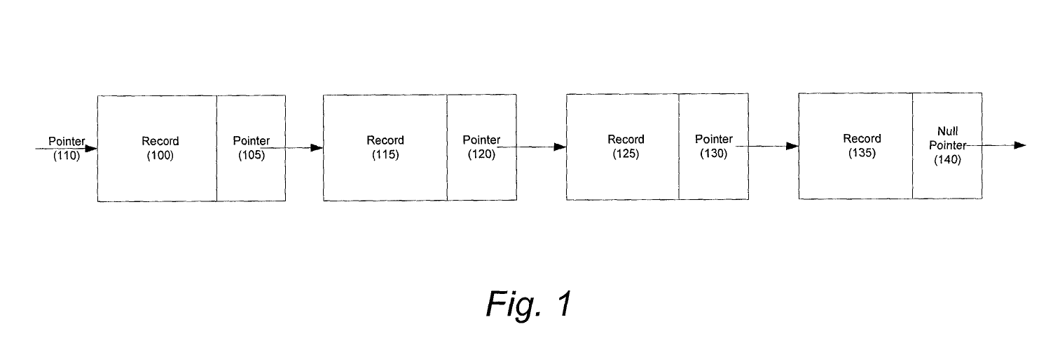

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION

The following is intended to provide a detailed description of an example of the invention and should not be taken to be limiting of the invention itself. Rather, any number of variations may fall within the scope of the invention which is defined in the claims following the description.

Introduction

The present invention provides a method and system for avoiding checking for null in a program by using profile feedback information to remove a check for null pointer and creating a fault to target translation table.

Profile Feedback

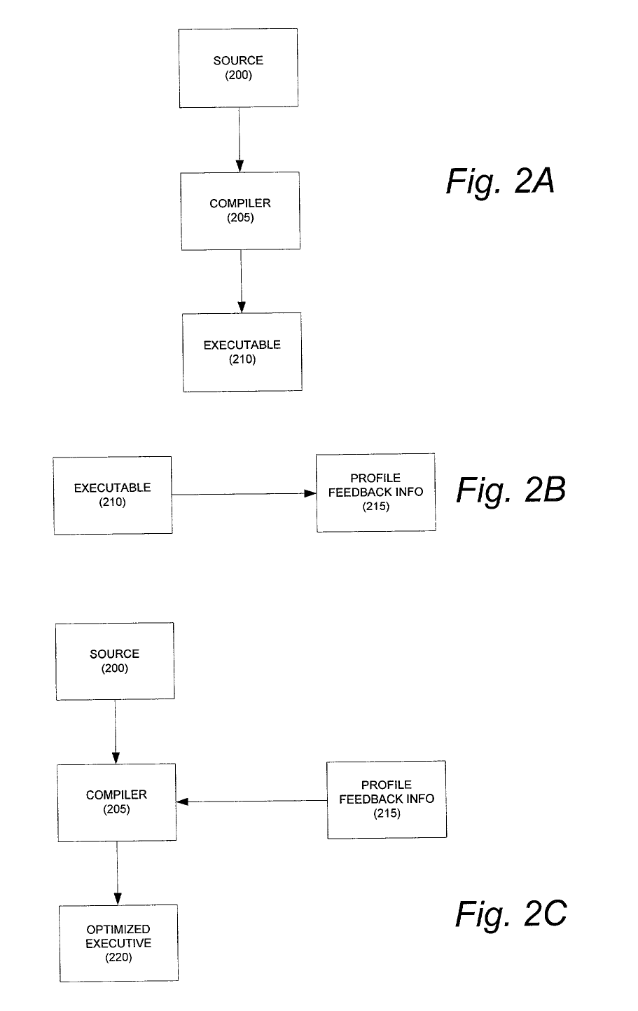

Now referring to FIG. 2A, a block diagram illustrate a first pass program compile. Source code typically is known as the code listing written by programmers that has yet to be compiled or translated by a computer. In this example, source code 200 is received by compiler 205. Compiler 205 can be part of a computer system that processes and/or makes use of source and executable code, where executable code is the program listing that the computer makes use of. Compiler 205 translates source code 200 into executable code 210. Executable code 210 can then be ran on the computer.

Now referring to FIG. 2B, a block diagram illustrates a program in which profile feedback information is extracted. As executable code 210 is ran on the computer, information regarding executable code 210 is emitted or extracted. The type of information includes interrelationships between various programming constructs such as pointers. This information reveals efficiencies and inefficiencies in how the executable program 210 performs. The information collected is referred to as profile feedback information 215.

Now referring to FIG. 2C, a block diagram illustrates optimized program feedback. Source 200 is recompiled by compiler 205; however, during this subsequent compile iteration compiler 205 also receives profile feedback information 215 which was collected during the previous iteration. Compiler 205 is able to generate an optimized executable program 220 based on previously collected information, in particular profile feedback information 215. Optimized executable program 220 runs faster than executable program 210.

Identifying Null Check Removal Opportunity

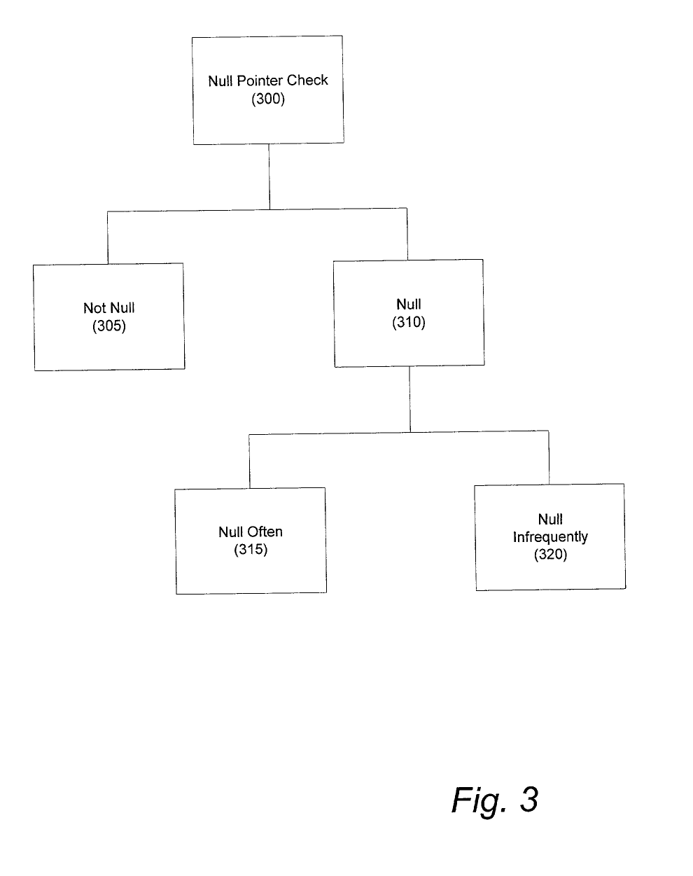

Now referring to FIG. 3, a block diagram illustrates the hierarchy of conditions related to a null pointer check in a program during compilation. When a null pointer check 400 is encountered two possible conditions can exist. The two conditions are a condition of not null 305 or a condition of null 310. If profile feedback information is gathered as described previously, information is made available that indicates the probability of the pointer being null is often 315 or the probability of the pointer being null is infrequent 320. In the event that the pointer is null infrequently 320, a condition is identified that allows the compiler to improve the speed of the program. Practical application does not require identification of an error condition or an expected scenario when the case occurs of a null pointer being infrequent 320. The specific infrequent occurrence of a null pointer is identified, and compiler 205 of FIG. 2 removes this particular null pointer check from the program and installs an entry in a fault to target translation table. The entry advises the computer to route the program to the uncommon scenario when a fault is caused because the pointer was actually null.

The following C program listing is an example of null pointer check as represented by block 300 of FIG. 3. In the event that the pointer is not null as represented by block 305 of FIG. 3, the address being pointed by the pointer is looked up in line 200 and other required tasks are performed in line 300. When the pointer is null, as represented by block 310 of FIG. 3, error handling is performed in line 500. In either case of not null or null, the program continues at line 600 and performs additional tasks.

| | |
|---|---|
| 100 | if (p != NULL) |

| | |
|---|---|
| 200 | // lookup content at address p |
| 300 | // perform other task |

| | |
|---|---|
| 400 | else |

| | |
|---|---|
| 500 | // error handling |

| | |
|---|---|
| 600 | // continue with the program |
| 700 | // end of program |

With the use of profile feedback and gathered information, program line 500 in the preceding program listing can be identified as executing infrequently as represented by block 320 of FIG. 3. If such is the case, the most common path in the program listing is line 100 followed by line 200 followed by line 300, and followed by line 600. If such a case is true, the preceding program can be modified to list the program lines as follows:

| | |
|---|---|
| 200 | // lookup content at address p |
| 300 | // perform other task |
| 600 | // continue with the program |
| 700 | // end of program |
| 500 | // error handling |
| 900 | // goto 600 |

Fault to Target Translation Table

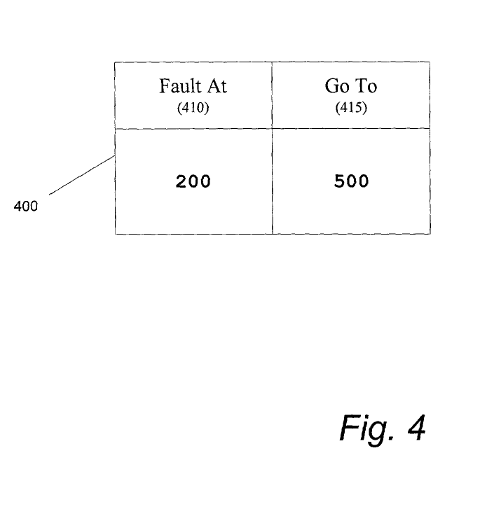

Now referring to FIG. 4 illustrated is a fault to target translation table. Table 400 provides a heading to identify faults 410 and a corresponding heading to go to a particular executable program line 415. An entry is made in the fault to target translation table of FIG. 4 that in the event of an exception at line 200 the program is routed to line 500.

Since the most common path of the program is line 100, line 200, line 300, and line 600, the modified program runs faster since the program does not have to check for the null pointer in line 100 and the program does not have to jump from line 300 to line 600. In the uncommon case when the pointer is actually null, a lookup action using the pointer causes a fault. A fault handler consults the fault to target table and instructs the program to continue at line 500.

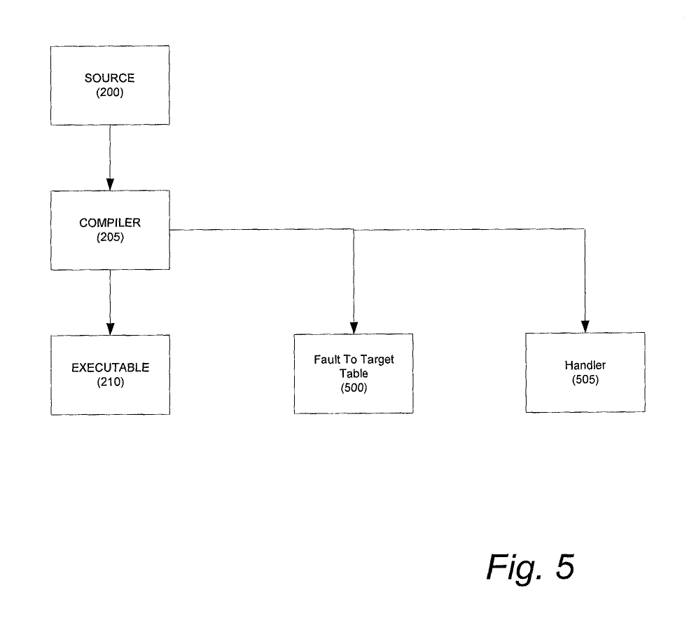

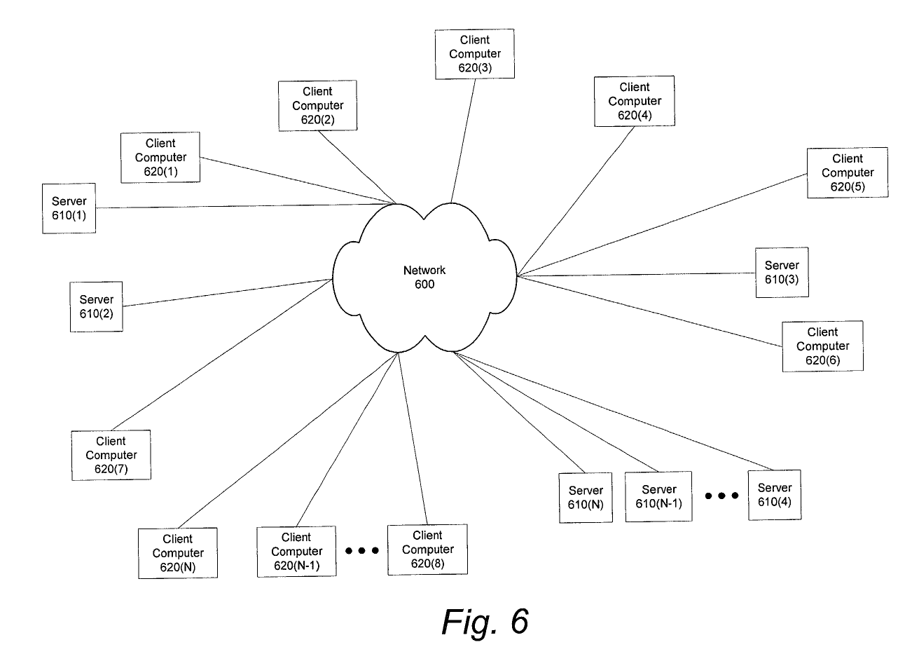

Now referring to FIG. 5, a flow chart illustrates source program compilation. When source program 200 is compiled by compiler 205, executable code 210 is generated. Compiler 205 also creates a fault to target table 500 and handler code 505. When an uncommon fault event occurs, the program goes to handler code 505 and in turn scans fault to target table 500, where the contents of fault to target table 500 are created and described in FIG. 4. According to the recorded address locations in fault to target table 500, the program is routed to the location where the particular uncommon fault event is handled. The fault to target table is generated by compiler 205 when any part of the program is implemented to take into account uncommon fault events. An Example Computing and Network Environment FIG. 6 is a block diagram illustrating a network environment in which a system according to the present invention may be practiced. As is illustrated in FIG. 6, network 600, such as a private wide area network (WAN) or the Internet, includes a number of networked servers 610(1)-(N) that are accessible by client computers 620(1)-(N). Communication between client computers 620(1)-(N) and servers 610(1)-(N) typically occurs over a publicly accessible network, such as a public switched telephone network (PSTN), a DSL connection, a cable modem connection or large bandwidth trunks (e.g., communications channels providing T1 or OC3 service) or wireless link. Client computers 620(1)-(N) access servers 610(1)-(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 620(1)-(N).

One or more of client computers 620(1)-(N) and/or one or more of servers 610(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 620(1)-(N) is shown in detail in FIG. 6.

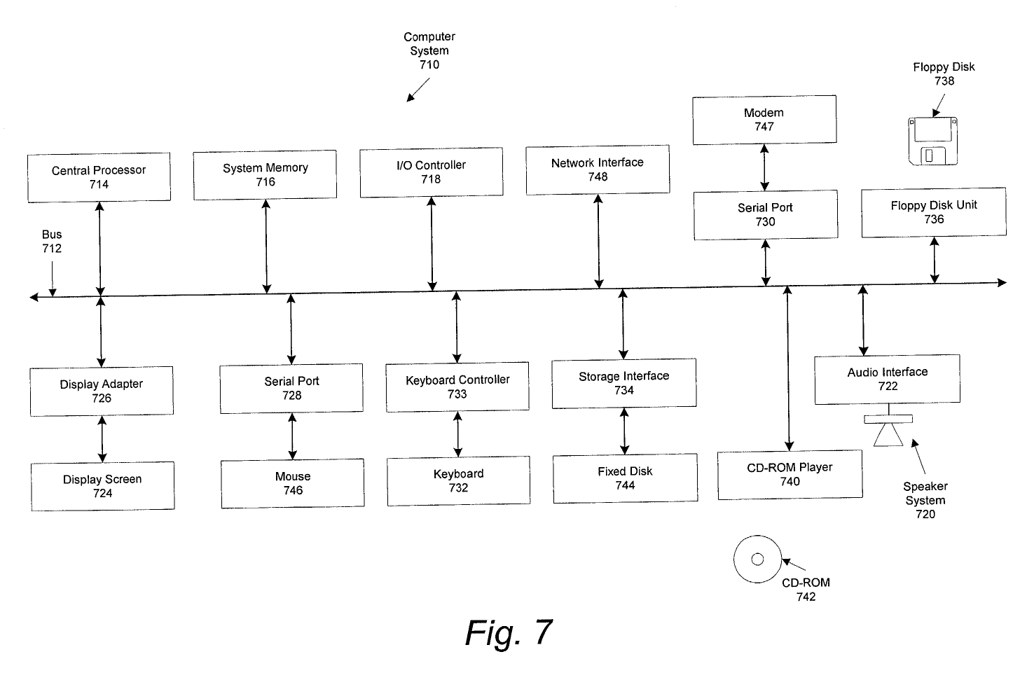

FIG. 7 depicts a block diagram of a computer system 710 suitable for implementing the present invention, and example of one or more of client computers 620(1)-(N). Computer system 710 includes a bus 712 which interconnects major subsystems of computer system 710 such as a central processor 714, a system memory 716 (typically RAM, but which may also include ROM, flash RAM, or the like), an input/output controller 718, an external audio device such as a speaker system 720 via an audio output interface 722, an external device such as a display screen 724 via display adapter 726, serial ports 728 and 730, a keyboard 732 (interfaced with a keyboard controller 733), a storage interface 734, a floppy disk drive 736 operative to receive a floppy disk 738, and a CD-ROM drive 740 operative to receive a CD-ROM 742. Also included are a mouse 746 (or other point-and-click device, coupled to bus 712 via serial port 728), a modem 747 (coupled to bus 712 via serial port 730) and a network interface 748 (coupled directly to bus 712).

Bus 712 allows data communication between central processor 714 and system memory 716, which may include both read only memory (ROM) or flash memory (neither shown), and random access memory (RAM) (not shown), as previously noted. The RAM is generally the main memory into which the operating system and application programs are loaded and typically affords at least 66 megabytes of memory space. The ROM or flash memory may contain, among other code, the Basic Input-Output system (BIOS) which controls basic hardware operation such as the interaction with peripheral components. Applications resident with computer system 710 are generally stored on and accessed via a computer readable medium, such as a hard disk drive (e.g., fixed disk 744), an optical drive (e.g., CD-ROM drive 740), floppy disk unit 736 or other storage medium. Additionally, applications may be in the form of electronic signals modulated in accordance with the application and data communication technology when accessed via network modem 747 or interface 748.

Storage interface 734, as with the other storage interfaces of computer system 710, may connect to a standard computer readable medium for storage and/or retrieval of information, such as a fixed disk drive 744. Fixed disk drive 744 may be a part of computer system 710 or may be separate and accessed through other interface systems. Many other devices can be connected such as a mouse 746 connected to bus 712 via serial port 728, a modem 747 connected to bus 712 via serial port 730 and a network interface 748 connected directly to bus 712. Modem 747 may provide a direct connection to a remote server via a telephone link or to the Internet via an internet service provider (ISP). Network interface 748 may provide a direct connection to a remote server via a direct network link to the Internet via a POP (point of presence). Network interface 748 may provide such connection using wireless techniques, including digital cellular telephone connection, general packet radio service (GPRS) connection, digital satellite data connection or the like. Many other devices or subsystems (not shown) may be connected in a similar manner (e.g., bar code readers, document scanners, digital cameras and so on). Conversely, it is not necessary for all of the devices shown in FIG. 7 to be present to practice the present invention. The devices and subsystems may be interconnected in different ways from that shown in FIG. 7. The operation of a computer system such as that shown in FIG. 7 is readily known in the art and is not discussed in detail in this application. Code to implement the present invention may be stored in computer-readable storage media such as one or more of system memory 716, fixed disk 744, CD-ROM 742, or floppy disk 738. Additionally, computer system 710 may be any kind of computing device, and so includes personal data assistants (PDAs), network appliance, X-window terminal or other such computing device. The operating system provided on computer system 710 may be MS-DOS®, MS-WINDOWS®, OS/2®, UNIX®, Linux® or other known operating system. Computer system 710 also supports a number of Internet access tools, including, for example, an HTTP-compliant web browser having a JavaScript interpreter, such as Netscape Navigators 8.0, Microsoft Explorer® 8.0 and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 710). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “closely connected”, or “closely coupled”, to each other to achieve the desired functionality.

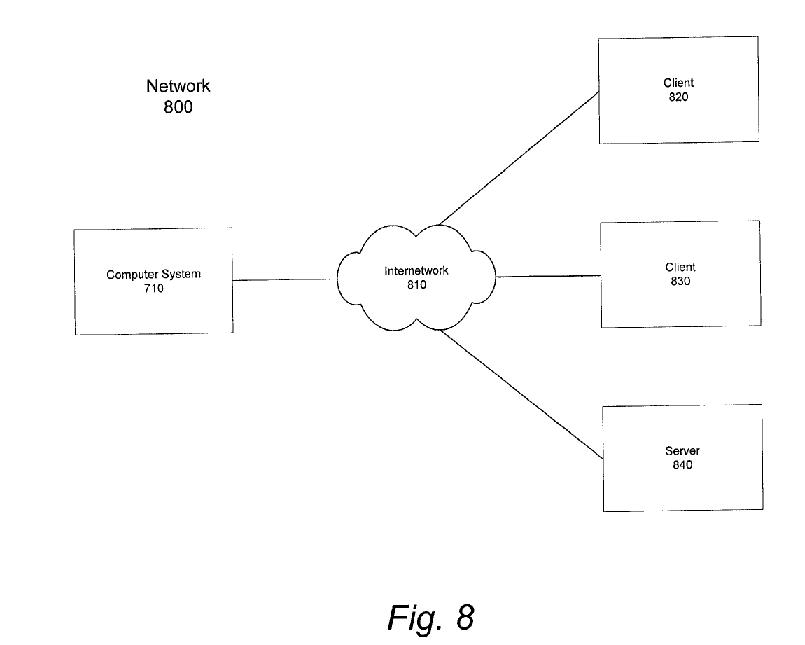

FIG. 8 is a block diagram depicting a network 800 in which computer system 810 is coupled to an internetwork 810, which is coupled, in turn, to client systems 820 and 830, as well as a server 840. Internetwork 810 (e.g., the Internet) is also capable of coupling client systems 820 and 830, and server 840 to one another. With reference to computer system 810, modem 847, network interface 848 or some other method can be used to provide connectivity from computer system 810 to internetwork 810. Computer system 810, client system 820 and client system 830 are able to access information on server 840 using, for example, a web browser (not shown). Such a web browser allows computer system 810, as well as client systems 820 and 830, to access data on server 840 representing the pages of a website hosted on server 840. Protocols for exchanging data via the Internet are well known to those skilled in the art. Although FIG. 8 depicts the use of the Internet for exchanging data, the present invention is not limited to the Internet or any particular network-based environment.

Referring to FIGS. 6, 7 and 8, a browser running on computer system 810 employs a TCP/IP connection to pass a request to server 840, which can run an HTTP “service” (e.g., under the WINDOWS® operating system) or a “daemon” (e.g., under the UNIX® operating system), for example. Such a request can be processed , for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included with in the scope of the invention as defined by the appended claims.

What is claimed is:

1. A method of bypassing an infrequent null pointer condition when compiling a source program comprised of:
creating a fault to target translation table of the infrequent null pointer condition;
relating the infrequent null pointer condition to a procedural instruction in the fault to target translation table; and
compiling the source program to an executable program.

2. The method of claim 1 further comprising:
gathering statistics as to the number of occurrences the infrequent null pointer condition occurs;
determining an acceptable rate of occurrence; and
entering the infrequent condition into the fault to target translation table if the infrequent null pointer condition does not exceed the acceptable rate of occurrence.

3. The method of claim 1 further comprising:
passing fault to target translation data from the fault to target translation table to the compiler using a handler program.

4. The method of claim 2 further comprising:
passing fault to target translation data from the fault to target translation table to the compiler using a handler program.

5. The method of claim 1 further comprising:
accessing the fault to target translation table during compiling of the source program.

6. The method of claim 2 further comprising:
accessing the fault to target translation table during compiling of the source program.

7. The method of claim 3 further comprising:
accessing the fault to target translation table during compiling of the source program.

8. The method of claim 4 further comprising:
accessing the fault to target translation table during compiling of the source program.

9. A computing system capable of bypassing an infrequent null pointer condition when compiling a source program comprising:
a processor;
a computer readable medium coupled to the processor; and
computer code, encoded in the computer readable medium, configured to cause the processor to:
create a fault to target translation table of the infrequent null pointer condition;
relate the infrequent null pointer condition to a procedural instruction in the fault to target translation table; and
compile the source program to an executable program.

10. The computing system of claim 9 wherein the processor is further configured to:
gather statistics as to the number of occurrences the infrequent null pointer condition occurs;
determine an acceptable rate of occurrence; and
enter the infrequent condition into the fault to target translation table if the infrequent null pointer condition does not exceed the acceptable rate of occurrence.

11. The computing system of claim 9 wherein the processor is further configured to:
pass fault to target translation data from the fault to target translation table to the compiler using a handler program.

12. The computing system of claim 10 wherein the processor is further configured to:
pass fault to target translation data from the fault to target translation table to the compiler using a handler program.

13. The computing system of claim 9 wherein the processor is further configured to:
access the fault to target translation table during compiling of the source program.

14. The computing system of claim 10 wherein the processor is further configured to:
access the fault to target translation table during compiling of the source program.

15. The computing system of claim 11 wherein the processor is further configured to:
access the fault to target translation table during compiling of the source program.

16. The computing system of claim 12 wherein the processor is further configured to:
access the fault to target translation table during compiling of the source program.

17. An apparatus to bypass an infrequent null pointer condition when compiling a source program comprised of:
means for creating a fault to target translation table of the infrequent null pointer condition;
means for relating the infrequent null pointer condition to a procedural instruction in the fault to target translation table; and
means for compiling the source program to an executable program.

18. The apparatus of claim 17 further comprised of:
means for gathering statistics as to the number of occurrences the infrequent null pointer condition occurs;
means for determining an acceptable rate of occurrence; and
means for entering the infrequent condition into the fault to target translation table if the infrequent null pointer condition does not exceed the acceptable rate of occurrence.

19. The apparatus of claim 17 further comprised of:
means for passing fault to target translation data from the fault to target translation table to the compiler using a handler program.

20. The apparatus of claim 18 further comprised of:
means for passing fault to target translation data from the fault to target translation table to the compiler using a handler program.

21. The apparatus of claim 17 further comprised of:
means for accessing the fault to target translation table during compiling of the source program.

22. The apparatus of claim 18 further comprised of:
means for accessing the fault to target translation table during compiling of the source program.

23. The apparatus of claim 19 further comprised of:
means for accessing the fault to target translation table during compiling of the source program.

24. The apparatus of claim 20 further comprised of:
means for accessing the fault to target translation table during compiling of the source program.

25. A computer program product that bypasses an infrequent null pointer condition when compiling a source program comprising:
a first set of instructions, executable on a computer system, configured to gather statistics as to the number of occurrences the infrequent null pointer condition occurs;
a second set of instructions, executable on the computer system, configured to determine an acceptable rate of occurrence; and
a third set of instruction, executable on the computer system, configured to enter the infrequent condition into the fault to target translation table if the infrequent null pointer condition does not exceed the acceptable rate of occurrence.

26. The computer program product of claim 25 further comprising:
a fourth set of instructions, executable on the computer system, configured to gather statistics as to the number of occurrences the infrequent null pointer condition occurs;
a fifth set of instructions, executable on the computer system, configured to determine an acceptable rate of occurrence; and
a sixth set of instructions, executable on the computer system, configured to enter the infrequent condition into the fault to target translation table if the infrequent null pointer condition does not exceed the acceptable rate of occurrence.

27. The computer program product of claim 25 further comprising:
a seventh set of instructions, executable on the computer system, configured to pass fault to target translation data from the fault to target translation table to the compiler using a handler program.

28. The computer program product of claim 26 further comprising:
a seventh set of instructions, executable on the computer system, configured to pass fault to target translation data from the fault to target translation table to the compiler using a handler program.

29. The computer program product of claim 25 further comprising:
an eighth set of instructions, executable on the computer system, configured to access the fault to target translation table during compiling of the source program.

30. The computer program product of claim 26 further comprising:
an eighth set of instructions, executable on the computer system, configured to access the fault to target translation table during compiling of the source program.

31. The computer program product of claim 27 farther comprising:
an eighth set of instructions, executable on the computer system, configured to access the fault to target translation table during compiling of the source program.

32. The computer program product of claim 28 further comprising:
an eighth set of instructions, executable on the computer system, configured to access the fault to target translation table during compiling of the source program.
